(19) United States
(12) Patent Application Publication
(10) Pub. No.: US 2026/0238675 A1
(43) Pub. Date: Aug. 13, 2026

(54) SYSTEMS AND METHODS FOR MITIGATING CYBERSECURITY RISKS OF INTERDEPENDENT ENTITIES

(71) Applicant: REGENTS OF THE UNIVERSITY OF MICHIGAN, Ann Arbor, MI (US)

(72) Inventors: Mingyan Liu, Ann Arbor, MI (US); Parinaz Naghizadeh Ardabili, Columbus, OH (US)

(21) Appl. No.: 18/514,348

(22) Filed: Nov. 20, 2023

Related U.S. Application Data
(60) Provisional application No. 63/427,547, filed on Nov. 23, 2022.

(51) Int. Cl. H04L 9/40

(52) U.S. Cl. CPC H04L 63/1441; H04L 63/1416

(57) ABSTRACT

Techniques are disclosed for customizing cybersecurity protection and/or mitigating cybersecurity risk for different ecosystems of cyber-entities which have cybersecurity interdependencies, and/or responsively adjusting cybersecurity protection based on changes to and cybersecurity incidents that occur in the ecosystems. The techniques may modify or adjust a cybersecurity risk score of a specific cyber-entity included in a group of cyber-entities based on the cybersecurity-dependent relationships which the cyber-entity has with other cyber-entities of the group; determine the collective group impact of a cybersecurity incident occurring at the specific cyber-entity based on the adjusted risk score; and initiate and/or perform one or more cybersecurity mitigation techniques based on the collective group impact. Responsive to changes to and/or cybersecurity incidents which occur within the cyber-entity ecosystem, cybersecurity risk scores and/or collective impacts may be updated, and modified, and/or new mitigation techniques based on the updated risk scores and/or collective impacts may be initiated and/or performed.

### CROSS REFERENCE TO RELATED APPLICATIONS

This application claims priority to U.S. Provisional Patent Application No. 63/427,547 filed on Nov. 23, 2022 and entitled “Systems and Methods for Mitigating Cybersecurity Risk of Interdependent Entities,” the entire contents of which are hereby incorporated by reference.

### STATEMENT OF GOVERNMENT INTEREST

This invention was made with government support under CNS1616575 and CNS1939006 awarded by the National Science Foundation, and FA8750-18-2-0011 awarded by the U.S. Air Force Research Laboratory. The government has certain rights in the invention.

### TECHNICAL FIELD

This application generally relates to systems and methods for mitigating cybersecurity risks of entities that have cybersecurity interdependencies.

### BACKGROUND

Cybersecurity or information technology (IT) security generally relates to the protection of computing devices, computer systems, computing networks, computing software (e.g., for services and/or other functionalities) stored and/or executed thereon, and electronic data stored thereon from cyberattacks such as manipulation, theft of, and/or damage to hardware, software, and/or stored electronic data and information, as well as from the disruption or misdirection of the services and functionalities that the devices, systems, networks, and/or software provide. Cyberattacks or cybersecurity breaches can include, for example, backdoor access, denial-of-service attacks, direct-access attacks, eavesdropping, multi-vector or polymorphic attacks, phishing, privilege escalation, reverse engineering, side-channel attacks, social engineering, spoofing, tampering, malware, and data destruction, to name a few. Cybersecurity techniques which are currently being utilized to secure a computing device, system, network, and/or software (which are generally and categorically referred to interchangeably herein, for purposes of ease of discussion, as a “cyber-entity” or an “entity”) can include, for example, firewalls, access controls, records management, sandboxes, cryptographic software, intrusion detection and prevention systems, anti-key loggers, anti-spyware, anti-malware, antivirus software, vulnerability or cybersecurity risk assessments and management, etc. Typically, cybersecurity risk assessments and mitigation thereof are performed on a single cyber-entity, such as a company IT infrastructure, a single laptop or personal computer, a private network, etc.

Recently, though, with the expanded reliance on the Internet and other public networks, and with the growth in various types, capabilities, access to wireless networks, and the outsourcing of products and services, cyber-entities are increasingly dependent, with respect to cybersecurity, on other cyber-entities, and vice versa. For example, a company's private computing network may utilize a third-party Virtual Private Network (VPN) provider or a third-party cloud storage provider, and multiple employee laptops (each of which may execute any number or types of downloaded third-party applications) may connect to the company's private computing network. As such, any cybersecurity breach of the provided VPN, the provided cloud storage, the employee laptops, and/or the third-party applications executing on the employee laptops may affect the cybersecurity of the company's private computing network. Such cybersecurity dependencies between different cyber-entities are generally and categorically referred to interchangeably herein for ease of discussion as “cybersecurity dependencies,” “cybersecurity-dependencies,” “cyber-dependencies,” or, simply, “dependencies.” Accordingly, the cybersecurity risk of a particular cyber-entity is becoming more complex to assess and mitigate at least due to its cyber-dependencies with other cyber-entities. Some electronic techniques for assessing and quantifying a particular cyber-entity's risk exposure have been developed, e.g., electronic techniques that explore, identify, locate, collect data from, and evaluate a company's network and assets for assessing cybersecurity risks and calculating corresponding cybersecurity risk scores, such as described in U.S. Patent Publication 2016/0110819 and in U.S. Pat. Nos. 9,294,498, 9,729,558, and 10,038,703, for example.

### SUMMARY

Generally speaking, the embodiments of the systems, methods, and devices described herein may customize cybersecurity protection for different ecosystems (e.g., groups, pluralities, etc.) of cyber-entities which have cybersecurity interdependencies. For example, embodiments of the systems, methods, and devices described herein may modify or adjust a cybersecurity risk score of a cyber-entity included in a group of cyber-entities based on the cybersecurity-dependent relationships the cyber-entity has with other cyber-entities of the group, and may initiate one or more cybersecurity mitigation techniques (e.g., for the cyber-entity, for other cyber-entities of the group, and/or for the group as a whole) based on the cyber-entity's adjusted cybersecurity risk score. In some embodiments, the systems, methods, and devices described herein may be responsive to changes in the cyber-entity ecosystem such as, for example, a change to the membership of the group of cyber-entities, a change at a member of the group of cyber-entities, an occurrence of a cybersecurity incident at one of the group members, and/or other types of events. For example, embodiments of the systems, methods, and devices described herein may modify or adjust respective cybersecurity risk scores of one or more cyber-entities included in the group based on the change. In these embodiments, one or more cybersecurity mitigation techniques (e.g., for one or more cyber-entities of the group of cyber-entities and/or for the group as a whole) may be initiated and/or performed based on the modified or adjusted cybersecurity risk scores of the one or more cyber-entities.

In an embodiment, a method of mitigating cybersecurity risks for a plurality of entities includes, for each entity included in the plurality of entities, obtaining a respective individual cybersecurity risk score of the each entity and an indication of a respective set of entities, of the plurality of entities, with which the each entity has cybersecurity dependencies, where the respective set of entities with which the each entity has cybersecurity dependencies is a respective set of interdependent entities of the each entity. The method also includes, based on the sets of interdependent entities of the plurality of entities and the respective individual cybersecurity risk score of a particular cyber-entity of the plurality of entities, determining, for the particular cyber-entity, a magnitude of a respective collective impact, across the plurality of entities, of an occurrence of one or more cybersecurity incidents at the particular cyber-entity relative to magnitudes of respective collective impacts, across the plurality of entities, of occurrences of the one or more cybersecurity incidents at other entities included in the plurality of entities. Additionally, the method includes adjusting the respective individual cybersecurity risk score of the particular cyber-entity based on the relative magnitude of the respective collective impact corresponding to the particular cyber-entity, and mitigating a cybersecurity risk to the plurality of entities based on the adjusted, respective individual cybersecurity risk score of the particular cyber-entity.

In an embodiment, a method of mitigating cybersecurity risks for a plurality of entities includes obtaining, for each entity included in the plurality of entities, an indication of a respective set of entities, of the plurality of entities, with which the each entity has cybersecurity dependencies, where the respective set of entities with which the each entity has cybersecurity dependencies is a respective set of interdependent entities of the each entity. The method also includes, based on the sets of interdependent entities of the plurality of entities, determining a collective impact, across the plurality of entities, of an occurrence of one or more cybersecurity incidents at a particular cyber-entity included in the plurality of entities. The collective impact may be based on a primary impact, to the particular cyber-entity, of the occurrence of the one or more cybersecurity incidents at the particular cyber-entity, and may be based on respective secondary impacts, to other entities included in the plurality of entities, of the occurrence of the one or more cybersecurity incidents at the particular cyber-entity. Further, the method includes mitigating a cybersecurity risk of the plurality of entities based on the collective impact, across the plurality of entities, of the occurrence of the one or more cybersecurity incidents at the particular cyber-entity.

In an embodiment, a method of mitigating cybersecurity risks for a specific entity included in a plurality of entities that has cybersecurity dependencies includes detecting or causing a change associated with one or more cybersecurity dependencies of a specific entity included in the plurality of entities and, based on the change, updating a collective impact, across the plurality of entities, of an occurrence of the one or more cybersecurity incidents at the specific entity. The updating may be based on the change and a set of other entities, of the plurality of entities, with which the specific entity has cybersecurity dependencies, where the set of other entities with which the specific entity has cybersecurity dependencies is a set of interdependent entities of the specific entity. Additionally, the method includes mitigating the cybersecurity risk of the specific entity based on the updated collective impact.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 depicts a block diagram of an example system for mitigating cybersecurity risks of and/or among a plurality of cyber-entities.

FIG. 2 depicts an example ecosystem of cyber-entities that includes cybersecurity interdependencies.

FIG. 3A is a flow diagram of an example method for mitigating cybersecurity risks for a plurality of cyber-entities.

FIG. 3B is a flow diagram of an example method for mitigating cybersecurity risks for a plurality of cyber-entities.

FIG. 4 is a flow diagram of an example method for mitigating cybersecurity risks for a specific cyber-entity included in a plurality of cyber-entities.

### DETAILED DESCRIPTION

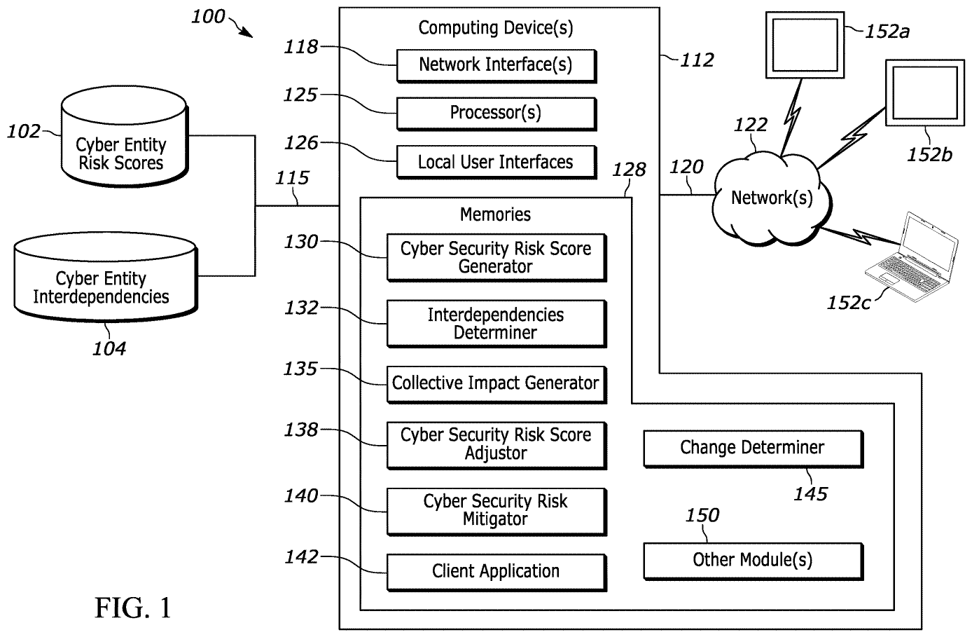

FIG. 1 illustrates a block diagram of an example system 100 for mitigating the cybersecurity risks of and/or among a plurality of cyber-entities. Typically, the plurality of cyber-entities includes cybersecurity-dependent cyber-entities. The example system 100 includes a cybersecurity risk score data store 102 and a cyber-entity interdependencies data store 104. Each of the data stores 102, 104 may be implemented using one or more suitable databases and/or one or more data storage devices. For example, the data stores 102, 104 may be implemented by a data bank or a data cloud. Further, although the data stores 102, 104 are shown in FIG. 1 as being separate data stores 102, 104, the data stores 102, 104 may share data platform hardware and/or software resources. In some embodiments, the data stores 102, 104 may be implemented as an integral data store.

The cybersecurity risk score data store 102 may store a plurality of cybersecurity risk scores of a multiplicity of cyber-entities, where each cybersecurity risk score is associated with a respective cyber-entity and is indicative of a level of cybersecurity risk or a cybersecurity risk exposure of the entity. As previously mentioned, and generally speaking, a “cyber-entity” or “entity,” as interchangeably used herein, refers to a target computing device, computing system, or computing network, or software that is stored and executable on a computing device, system, or network to provide a service or a particular functionality. Cybersecurity risk scores stored in the data store 102 may have been determined (e.g., pre-determined) and stored into the cybersecurity risk score data store 102 by any suitable means, such as via manual techniques and/or via electronic or automated techniques, such as machine learning techniques, artificial intelligence techniques, etc. For example, at least some of the cybersecurity risk scores stored in the data store 102 may have been determined from or based on one or more actuarial techniques, e.g., actuarial tables and/or schedules. Additionally or alternatively, at least some of the cybersecurity risk scores stored in the data store 102 may have been determined by utilizing one or more machine learning, artificial intelligence, and/or other types of electronic techniques. The machine learning, artificial intelligence, and/or other types of electronic techniques may determine a cybersecurity risk score for a subject entity based on, for example, current cybersecurity policies, processes, and products utilized at or by the subject entity, and optionally based on a set of interdependent entities of the subject entity, e.g., such as described below. At least some of the cybersecurity risk scores stored in the data store 102, though, may be stand-alone risk scores which do not take into account any cyber-ecosystem in which a cyber-entity is included, and/or do not take into account any cybersecurity-dependent relationships the cyber-entity may have with other cyber-entities, e.g., within the ecosystem. In some situations, at least some of the cybersecurity risk scores stored in the data store 102 may be interdependent risk scores, as is discussed elsewhere within this document.

The interdependencies data store 104 may store, for each cyber-entity of a multiplicity of cyber-entities, an indication of one or more other entities on which the subject entity is cyber-dependent (if any), and an indication of one or more other entities which are cyber-dependent on the subject entity (if any). Generally speaking, and as utilized herein, a first cyber-entity is cyber-dependent (e.g., has a cybersecurity dependency) on a second cyber-entity when a cybersecurity breach or attack that occurs at the second cyber-entity has an impact on the cybersecurity of the first cyber-entity. For example, a hard drive and operating system of a laptop computer can be cyber-dependent on a VPN, an antivirus application, and an email application which execute, at least in part, on the laptop computer, as a security breach of the VPN, the web browser, or the email application can affect the cybersecurity of the hard drive and operating system of the laptop computer. Similarly, a cybersecurity breach of the laptop computer's operating system (which may have been caused, for example, by another application executing at the laptop), may affect the cybersecurity of the VPN, web browser, or email application which are executing, at least in part, on the laptop computer. As such the VPN, web browser, or email application may be cyber-dependent on the laptop's operating system. Further, the VPN may provide (and thus may be cyber-dependent on) a web- or software-as-a-service provided by a third-party company, and the service provided by the third-party company may be cyber-dependent on the cloud platform on which the service is hosted, where the cloud platform is provided by yet another third-party company. Still further in the example, the cloud platform may also host the service side of the email application which executes at least partly at the laptop. Thus, the set of cyber-interdependencies of a subject cyber-entity can include one-way cyber-dependencies (e.g., all known one-way cyber-dependencies), if any (including one-way dependencies of the subject cyber-entity on other cyber-entities, and one-way dependencies of other cyber-entities on the subject cyber-entity), and can include mutual or two-way cyber-dependencies between the subject cyber-entities and other entities (e.g., all known mutual or two-way cyber-dependencies), if any. Additionally, in some ecosystems, various interdependent entities of the subject entity may also have direct cyber-interdependencies with each other. The set of other entities with which the subject entity has one-way and/or mutual cyber-dependencies is generally referred to herein as the set of “interdependent” entities of the subject entity, and the interdependencies data store 104 may store an indication of the respective set of interdependent entities of each cyber-entity included in the multiplicity of cyber-entities. It is also noted that the set of cyber-entities for which cybersecurity risk scores are stored in the cybersecurity risk score data store 102 and the set of cyber-entities indicated by the interdependencies data store 104 may or may not be the same set of cyber-entities.

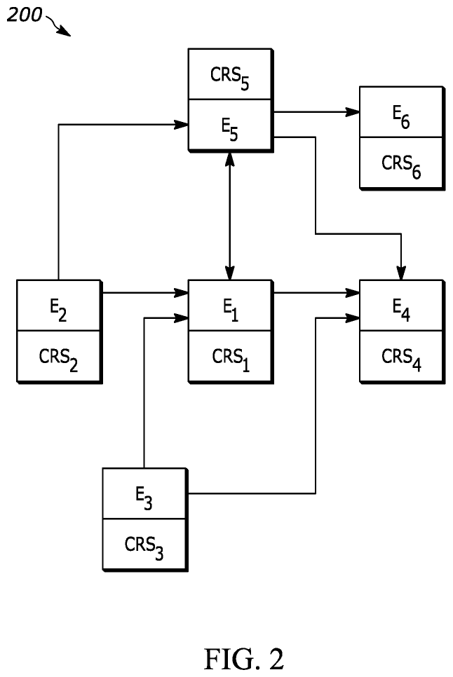

To illustrate cyber-interdependencies (which, for the purposes of ease of reading, is also interchangeably referred to here as “interdependencies”), FIG. 2 depicts an example set or ecosystem 200 of six cyber-entities E₁-E₆ which have cyber-interdependencies within the set/ecosystem. As such, the set 200 is a set of interdependent cyber-entities, which is also referred to interchangeably herein as an interdependent set 200 of cyber-entities. That is, various members E₁-E₆ of the set 200 have cyber-dependencies on or with one or more other members E₁-E₆ of the set 200. Said another way, each cyber-entity E₁-E₆ of the set 200 has a respective cyber-dependent relationship (whether one-way or mutual) with at least one other cyber-entity included in set 200. The arrows shown in FIG. 2 represent the directional cyber-dependencies between the various set members E₁-E₆. As such, E₁ has a respective one-way cyber-dependency (or, is cyber-dependent) on E₂ and E₃, and E₁ is mutually cyber-dependent with E₅. E₅ is mutually cyber-dependent with E₁ and has a one-way cyber-dependency on E₂. E₄ has one-way cyber-dependencies on E₁, E₃, and E₅, and E₆ has a one-way cyber-dependency on E₅. As such, the set of interdependent entities of cyber-entity E₁ includes E₂, E₃, E₄, and E₅; the set of interdependent entities of cyber-entity E₂ includes E₁ and E₅; the set of interdependent entities of cyber-entity E₃ includes E₁ and E₄; the set of interdependent entities of cyber-entity E₄ includes E₁, E₃, and E₅; the set of interdependent entities of cyber-entity E₅ includes E₁, E₂, E₄, and E₆; and the set of interdependent entities of cyber-entity E₆ includes E₅. The entire group of cyber-interdependencies of the members E₁-E₆ of the set 200 is generally and interchangeably referred to herein as a “cyber-interdependency map,” “cyber-interdependency web,” “interdependency map,” or “interdependency web” of the set 200, and an indication of interdependency web of the set 200 may be stored in the interdependencies data store 104 of the system 100.

As also depicted in FIG. 2, each cyber-entity E₁-E₆ has a respective cybersecurity risk score CRS₁-CRS₆, which generally is indicative of a respective level of cybersecurity risk of the each cyber-entity and/or of a magnitude of cyber risk exposure of the each cyber-entity. At least some of the cybersecurity risk scores CRS₁-CRS₆ may be pre-determined and stored in the cybersecurity risk score data store 102 of the system 100, for example. Additionally or alternatively, at least some of the cybersecurity risk scores CRS₁-CRS₆ may be (initially) determined and/or updated in-line with the execution of any one or more methods described herein. Any cybersecurity risk scores CRS₁-CRS₆ which are determined/updated in-line with the execution of any one or more methods described herein may be stored into the cybersecurity risk score data store 102. As such, for a particular cyber-entity Eₓ, the cybersecurity risk score data store 102 may store a stand-alone cybersecurity risk score CRSₓ, e.g., a cybersecurity risk score that is determined without consideration to any cyber-dependencies of the subject cyber entity, and optionally may store, for particular cyber-entity Eₓ, one or more related, interdependent cybersecurity risk scores CRSₓ₁, CRSₓ₂, . . . , CRSₓₙ, each of which may be indicative of a respective magnitude of cybersecurity risk exposure introduced by the cyber-entity Eₓ into different ecosystems or different sets of cyber-entities that have interdependencies. An indication of the respective ecosystem may be stored in conjunction with an indication of the related, interdependent cybersecurity risk scores of the particular cyber-entity Eₓ, if desired. As such, each of the interdependent cybersecurity risk scores CRSₓ₁, CRSₓ₂, . . . , CRSₓₙ of the cyber-entity Eₓ may be based on the stand-alone cybersecurity risk score of Eₓ and the respective interdependency map of the ecosystem corresponding to each interdependent cybersecurity risk score. Indeed, the cybersecurity risk score data store 102 may store an indication of a respective interdependency web or map of each ecosystem.

Returning now to FIG. 1, the system 100 may include one or more servers or computing devices 112, which are interchangeably referred to herein as the “servers 112,” the “computing devices 112,” the “system computing devices 112,” or the “system computing devices 112,” and which may be implemented, for example, by a bank of servers, a cloud computing system, one or more networked computing devices, or any other suitable arrangement of one or more computing devices. As shown in FIG. 1, the system computing devices 112 may be communicatively connected to the cybersecurity risk score data store 102 and to the interdependencies data store 104 via one or more communication and/or data networks 115, which may include one or more private and/or semi-private networks, and may include any number of wired and/or wireless networks. In some implementations, the system computing devices 112 may additionally or alternatively be communicatively connected to the cybersecurity risk score data store 102 and/or to the interdependencies data store 104 in a remote manner, e.g., via one or more network interfaces 118 and one or more links 120 to one or more digital data and/or communication network(s) 122. The digital network(s) 122 may include one or more proprietary networks, a secure public Internet, a virtual private network, and/or some other type of network, such as dedicated access lines, plain ordinary telephone lines, satellite links, wireless links, wired links, combinations of these, etc.

The system computing devices 112 may include one or more processors 125, one or more local user interfaces 126, and one or more tangible, non-transitory memories 128 on which programs, applications, instructions, and/or routines 130-150 pertaining to mitigating cybersecurity risks of and/or among interdependent cyber-entities are stored. The one or more local user interfaces 126 may include any type of user interface which is locally provided by the system computing devices 112, for example, screens, touchscreens, keyboards, touch pads, mice, microphones, speakers, scanners, cameras, and/or other optical, auditory, and/or physical user interface devices.

The one or more memories 128 may include one or more tangible, non-transitory memories which are included in, for example, one or more computing devices, a data bank, a data cloud, or any suitable data storage platform. As shown in FIG. 1, the memories 128 store various modules or components such as a cybersecurity risk score generator 130, an interdependencies determiner 132, a collective impact generator 135, a cybersecurity risk score adjustor 138, a cybersecurity risk mitigator 140, a client application 142 (where respective instances of the client application 142 may be downloadable or otherwise delivered to one or more other devices 152a-152c for execution thereon), and a change determiner 145. The memories 128 may store one or more other modules, components, programs, applications, etc. (which are generally denoted by reference 150), each of which comprises respective computer-executable instructions that are executable by the one or more processors 125.

The modules or components 130-150 stored on the one or more memories 128 may contain or be configured with respective machine- or computer-readable or computer-executable instructions or modules (e.g., software, firmware, etc.) 130-150 for execution by the one or more processors 125. For example, the sets of instructions 130-150 may be implemented as one or more programs, applications, instructions, services, modules, routines, and the like, which may be executed by the one or more processors 125 to perform various tasks associated with mitigating the cybersecurity risks of and/or among interdependent entities. In an embodiment, some of the instructions 130-150 may comprise respective sets of computer-executable instructions which, when executed by the processors 125, cause the system 100 to execute at least a portion of embodiments of any or more of the methods described herein, such as the method 300, and/or the method 400. In some implementations, one or more of the sets of instructions 130-150 may operate in conjunction with other devices 152a-152c (and in some situations, with applications executing thereon) to perform various tasks associated with providing cybersecurity risk mitigation to a set of interdependent entities (e.g., associated with mitigating cybersecurity risks of the set of interdependent entities), and/or to perform at least portions of one or more of the methods described herein. It is noted that although FIG. 1 depicts only three other devices 152a-152c which are remotely located from the system 100, the system 100 may communicatively connect to any number of other devices 152, some of which may be located remotely from the system 100 (e.g., via respective communicative connections over the networks 122), and some of which may be local to the system 100 (e.g., via a communicative connection to the network 115 or via a direct communicative connection with the system 100). Further, although FIG. 1 depicts the modules or components 130-150 as separate modules or components, this is only for ease of discussion herein. Indeed, in embodiments, any two or more modules 130-150 may be implemented within the system 100 as an integral module or component, if desired.

Turning now to the other devices 152a-152c, each device 152a, 152b, 152c may be, for example, a personal computer, a cellular phone, a smart device, a mobile communications device, a tablet, a laptop, a desktop computer, another type of personal electronic device (PED) which may be operated by a user, etc., and may be a mobile or stationary computing device. For ease of discussion and clarity purposes, though, the devices 152a-152c are generally referred to herein as PEDs 152 in a non-limiting manner. Generally speaking, and as shown in FIG. 1, each of the PEDs 152a-152c may provide (e.g., to a user or to an application executing on the device 152) remote access to the system 100, e.g., via the one or more links 120 and the one or more networks 122. Each PED 152 may store and execute a respective instance of a client application 142 which has been downloaded from the servers 112 or otherwise loaded onto the PED 152. Additionally or alternatively, each PED 152 may execute a web browser via which a user or another application executing at the PED 152 may access a portal or virtual private network of the system 100, e.g., via the network(s) 115, 122, etc. In some implementations, at least one of the PEDs 152a-152c may provide a user interface via which users can access the system 100.

Generally speaking, where the digital network(s) 122 comprise the Internet or other IP-based communication network, data communication between PEDs 152 and the system computing devices 112 may take place over the digital networks 122 via a protocol of the Internet protocol suite (e.g., TCP/IP, UDP, SCTP, various application layer protocols, etc.) and/or other suitable protocol. The communicative connections or links 120 which are respectively established between the PEDs 152 and the system computing devices 112 may be implemented by using any known communication technique, such as by establishing sessions therebetween, tunneling, circuit-switching, virtual circuit switching, etc.

Still further, it will be appreciated that although only one computing device 112 is depicted in FIG. 1 as being included in the system 100, multiple computing devices 112 may be provided for the purpose of distributing server load, hosting and/or executing different ones of the applications 130-150, implementing different portions of an electronic web interface, servicing different remote instances of client applications 142, etc.

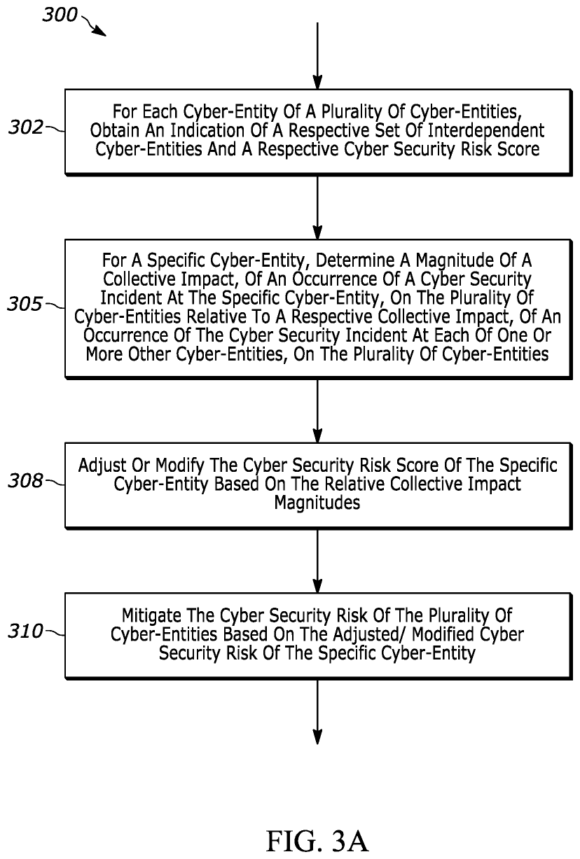

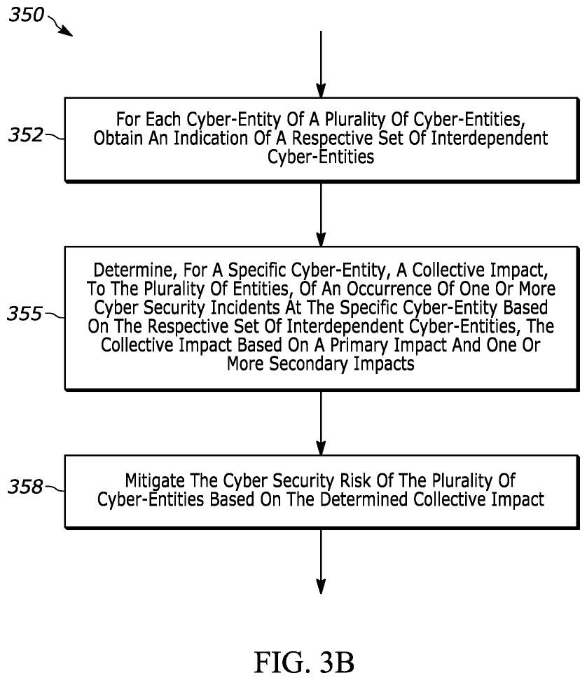

FIG. 3A depicts a flow diagram of an example method 300 for mitigating cybersecurity risks for a plurality of cyber-entities, such as a plurality of cyber-entities in which cybersecurity interdependencies are present. The method 300 may operate as a stand-alone method or in conjunction with at least portions of the methods 350 and 400 described herein. Additionally or alternatively, the method 300 may operate in conjunction with embodiments of at least a portion of the system 100 of FIG. 1 and of any one or more components and/or devices related thereto (such as, for example, the network(s) 122, the data stores 102, 104, the PEDs 152a-152c, etc.), and/or with other systems, processors, databases and/or devices. For example, the computing device(s) 112 may execute at least a portion of the method 300, at least a portion of the method 300 may be executed with respect to the example set 200 of cyber-entities depicted in FIG. 2, and/or at least a portion of the method 300 may be executed with respect to other sets of interdependent cyber-entities. In some arrangements, one or more of the components of the system 100 may execute an instance of the method 300, either individually or jointly. For example, the cybersecurity risk score generator 130, the interdependencies determiner 132, the collective impact generator 135, the cybersecurity risk score adjustor 138, and the cybersecurity risk mitigator 140 may perform at least a portion of the method 300. For ease of discussion, though, and not for limitation purposes, the method 300 is discussed with simultaneous reference to FIGS. 1 and 2. Further, the method 300 may include additional or alternate steps other than those described with respect to FIG. 3A, in embodiments.

Generally speaking, the method 300 may include adjusting or modifying a cybersecurity risk score of a particular cyber-entity (e.g., a subject cyber-entity) based on cyber-dependencies of the particular cyber-entity with other cyber-entities within a plurality of cyber-entities (e.g., within an ecosystem of cyber-entities that includes interdependent cyber-entities), and in some cases based on an entire web of interdependencies of the plurality of cyber-entities or ecosystem in which the particular cyber-entity is included. The method 300 may further include mitigating a cybersecurity risk of the particular cyber-entity based on the adjusted cybersecurity risk score of the particular cyber-entity, and in some cases may include mitigating, based on the adjusted cybersecurity risk score of the particular cyber-entity, the cybersecurity risk of two or more entities included in the plurality of entities or even, in some implementations, mitigating, based on the adjusted cybersecurity risk score of the particular cyber-entity, the cybersecurity risk of the plurality of entities, e.g., as a whole. As previously mentioned, the terms “cyber-entity” and “entity” are utilized interchangeably herein for ease of reading (and not limitation) purposes.

For example, at a block 302, the method 300 may include obtaining a respective (e.g., an individual) cybersecurity risk score of each entity included in a plurality of entities. As previously discussed, a cybersecurity risk score of an individual entity is indicative of a level of cybersecurity risk or a magnitude of cybersecurity risk exposure of the individual entity. In an embodiment, at least some of the respective individual cybersecurity risk scores of the entities may be obtained or retrieved from the cybersecurity risk score data store 102. Cybersecurity risk scores that are stored in and obtained from the cybersecurity risk score data store 102 may have been previously determined, for example, based on one or more actuarial techniques (such as actuarial tables and/or actuarial schedules) and/or based on one or more manual and/or electronic techniques (such as machine learning and/or other types of artificial intelligence techniques) which evaluate an entity's network, assets, and cyber-related data to assess cybersecurity risks thereof and calculate or otherwise determine a corresponding cybersecurity risk score.

In an embodiment, at least some of the respective individual cybersecurity risk scores obtained at the block 302 may be calculated in-line with an execution of the method 300 by utilizing any suitable means, such as by utilizing one or more manual techniques and/or one or more electronic techniques (such as machine learning and/or other types of artificial intelligence techniques). Such machine learning and/or other types of artificial intelligence techniques may automatically evaluate an entity's network, assets, and cyber-related data to assess cybersecurity risks thereof (including, for example, current cybersecurity policies, processes, and products utilized by the entity), and may calculate a corresponding cybersecurity risk score that is indicative of a level of cybersecurity risk and/or a magnitude of cybersecurity risk exposure. Cybersecurity risk scores which are calculated (or re-calculated) in-line with the execution of the method 300 may be stored into the cybersecurity risk score data store 102. Typically, though, and not necessarily, the cybersecurity risk scores that are obtained at the block 302 are stand-alone risk scores that do not take into account any cyber ecosystem in which the subject entity is included and/or do not take into account any cybersecurity-dependent relationships of the subject entity. In an example implementation, the cybersecurity risk score generator 130 may perform at least a portion of the block 302.

Additionally at the block 302, the method 300 may include, for each entity included in the plurality of entities, obtaining an indication of a respective set of entities, of the plurality of entities, with which the each entity has cybersecurity dependencies. As previously discussed, a set of the entities with which a subject entity has cybersecurity dependencies is generally referred to herein as “a set of interdependent entities” of the subject entity, where the set of interdependent entities of the subject entity typically includes all entities with which the subject entity has a one-way dependency and all entities with which the entity has a mutual dependency. Accordingly, at the block 302, the method 300 may include obtaining an indication of a respective set of interdependent entities of each entity included in the plurality of entities. In an embodiment, at least some of the respective sets of interdependent entities of the entities included in the plurality of entities may be obtained at least in part, for example, by accessing the information stored in the cyber-entity interdependencies data store 104. In some embodiments, at least some of the respective sets of interdependent entities of the entities included in the plurality of entities may be determined or discovered, at least in part, in-line with the execution of the block 302, e.g., by utilizing any suitable electronic techniques to assess the cyber assets of an entity for its cyber-dependencies (e.g., crawling, auditing, prompting for data entry, etc.). In these embodiments, any determined or discovered sets of interdependent entities may be stored into the interdependencies data store 104. In an embodiment, at the block 302, the method 300 may include obtaining an indication of the comprehensive or complete web of interdependencies of the plurality of entities in which the subject entity is included. In an example implementation, the interdependencies generator 135 may perform at least a portion of the block 302.

At a block 305, the method 300 may include, for a particular entity (e.g., a subject entity) of the plurality of entities, determining, for the particular or subject entity, a magnitude of a respective collective impact, across the plurality of entities, of an occurrence of one or more cybersecurity incidents at the subject entity relative to magnitudes of respective collective impacts, across the plurality of entities, of occurrences of the one or more cybersecurity incidents at one or more other entities included in the plurality of entities. In an example implementation, the collective impact generator 135 may perform the block 305. The determination 305 may be based on the sets of interdependent entities of the plurality of entities and the individual cybersecurity risk score of the subject entity, for example. In some implementations, the determination 305 may be based on the respective individual cybersecurity risk scores of one or more other entities of the plurality of entities (which may include one, two, or more other entities, and may include an entirety of the remainder of the plurality of entities or a subset thereof) in addition to the sets of interdependent entities of the plurality of entities and the individual cybersecurity risk score of the subject entity.

Further, the collective impact attributable to the subject entity may include or be based on an observation, quantification, or measurement of the collective impact due to one or more actual occurrences of cybersecurity incidents at the subject entity. Additionally or alternatively, the collective impact attributable to the subject entity may include or be based on an estimation, prediction, or projection of the collective impact were the one or more cybersecurity incidents to occur at the subject cyber-entity. In some embodiments, at the block 305, the method 300 may additionally include determining the respective collective impact attributable to the subject entity and/or determining the respective collective impact attributable to at least one of the one or more other entities. Accordingly, the determining of a respective collective impact attributable to a particular cyber-entity included in the plurality of entities due to an occurrence of the one or more cybersecurity incidents at the particular cyber-entity may include observing, quantifying, or measuring the collective impact due to an actual occurrence at the particular cyber-entity, and/or may include estimating, predicting, or projecting the collective impact were the one or more cybersecurity incidents to occur at the particular entity.

A cybersecurity incident may be an adverse cybersecurity incident, such as a cyberattack or other offensive action that is/was initiated by another party and that is/was at least partially successful and thus affects/affected one or more cyber assets of the attacked cyber-entity. As such, an adverse cybersecurity incident occurring at a specific cyber-entity may include a cybersecurity breach or other type of cyberattack which, when successful, results in the manipulation, theft, damage, or loss of hardware, software, and/or electronic data or information of the specific cyber-entity. Other examples of adverse cybersecurity incidents which are not perpetrated by a third party may be possible, though, such as software bugs, human errors, inadvertent or unknown race conditions, internal attacks, and the like. Furthermore, a cybersecurity incident may be a non-adverse or beneficial cybersecurity incident, such a software update and/or patch that fixes known cybersecurity risks or otherwise provides more cybersecurity protection as compared to a previous version, the addition of a type of cybersecurity protection which was previously not included in the ecosystem, a removal of a rogue or compromised cyber-entity from the ecosystem, etc.

Additionally, a “collective impact” to or across a group, plurality, or ecosystem of cyber-entities due to the occurrence of one or more cybersecurity incidents, as utilized herein, generally refers to an impact or effect to the cybersecurity of the group (e.g., to any member of the group, to the group as a whole, etc.). A collective impact may include, for example: the manipulation, theft, damage, and/or loss of hardware, software, and/or electronic data or information (e.g., of any cyber assets of the group); an amount, degree, magnitude, or level of damage to the hardware, software, and/or electronic data of the group (e.g., of one or more cyber assets of the group); a cost of recovering, repairing, and/or replacing hardware, software, and/or electronic data of the group (e.g., of one or more cyber assets of the group); a cost of restoring any services and functionalities provided by the group which were disrupted, misdirected, or otherwise, including, for example, the recovery, repair, and/or replacement of services, functionalities, and/or related data, the compensation and/or other types of remediation provided to consumers of the services and functionalities which were compromised, lost revenue attributable to the occurrence of one or more cybersecurity incident(s), etc. ; a change to the cost of providing cybersecurity for the hardware, software, and/or electronic data of the group (e.g., of any cyber assets of the group), which may include products, labor, and the like; a change in a probability of a future occurrence of a cybersecurity breach of and/or a successful cyberattack on the group that would result in the manipulation, theft, damage, and/or loss of hardware, software, and/or electronic data or information (e.g., of any cyber assets of the group); a change to a level of cybersecurity risk of the group of cyber-entities as a whole; a change to an overall cybersecurity risk exposure of the group as a whole; a change to the level of cybersecurity risk and/or the magnitude of cybersecurity risk exposure of one or more members of the group; and/or other impacts. Typically, a collective impact of or across a group of cyber-entities may be quantifiable, and thus may be indicated by a corresponding magnitude or level. A collective impact of or across a group of cyber-entities may be positive or negative. For example, the collective impact may result in an increase of cybersecurity risk to the group of entities or may result in a decrease in cybersecurity risk to the group of entities. A collective impact may be measured, observed, or otherwise determined after an occurrence of a cyberattack (e.g., an actual or resultant collective impact), or a collective impact may be estimated, predicted, or projected.

Further, a collective impact to or across a group of cyber-entities may include a primary impact, and may optionally include one or more secondary impacts. A primary impact of a cybersecurity incident occurring at a subject entity typically occurs when the subject entity is or was the direct object of the occurrence of the cybersecurity incident (e.g., is a direct target of a cyberattack, executes code that has a bug, etc.), whereas a secondary impact of the occurrence of the cybersecurity incident at the subject entity may occur at another entity of the group with which the subject entity has a cyber-dependency. In an example scenario, a malware cyberattack may breach a server, and a primary impact of the malware cyberattack may be a manipulation of various applications hosted on the server. The server may have multiple cyber-dependencies; for instance, numerous PEDs may execute clients of the various applications hosted on the server. As such, the manipulated applications hosted on the server may in turn breach each PED via the clients executing at the PEDs, thereby causing secondary impacts, of the server breach, at the PEDs. Accordingly, in this example scenario, the collective impact to the group of cyber-entities including the server and the PEDs on which the clients execute may include the primary impact to the server and the respective secondary impacts to the PEDs. Further, if any of the breached PEDs has other cyber-dependencies with other cyber-entities within the group which can be affected or impacted (e.g., in a “third-removed” manner) by the breach at the subject entity, those tertiary impacts may be included in or considered towards determining the collective impact of the cyberattack at the subject entity on the group. Of course, any still further-removed impacts may also be included in and/or considered when determining the collective impact, across a group of cyber-entities, of a cybersecurity incident occurring at the subject entity. As such, a collective impact of the cybersecurity incident occurring at the subject entity includes not only the (primary) impact on the subject entity, but also can include any spillover (secondary, tertiary, etc.) impacts to other entities within the group.

To illustrate, consider an example scenario in which the example set 200 of interdependent cyber-entities E₁-E₆ shown in FIG. 2 is subject to an occurrence of a cybersecurity incident at E₁, such as a cyberattack. In this illustrative scenario, at the block 305, the magnitude of the collective impact “CI₁” of the cybersecurity incident occurring at E₁ may be determined based on the cybersecurity risk score CRS₁ of E₁ and the interdependency web of the set 200. CI₁ may include or be based on, for example, the primary impact of the cybersecurity incident occurring at entity E₁ and any secondary, tertiary, etc. impacts experienced by any of the other entities E₂-E₆ due to the cybersecurity incident occurring at entity E₁.

Additionally in the example scenario, the magnitudes of respective collective impacts CIₓ of the cybersecurity incident occurring at one or more of the other cyber-entities E₂-E₆ (which, for ease of reading, is denoted herein using the syntax Eₓ) may be determined in a manner similar that of the collective impact CI₁ of the cybersecurity incident occurring at E₁. For example, each other entity Eₓ within the set 200 may be individually or separately considered as the direct object of the occurrence of the cybersecurity incident, and a corresponding collective impact CIₓ may be determined based on the cybersecurity risk score CRSₓ of the other cyber-entity Eₓ and the interdependency web of the set 200. Subsequently, at the block 305, the magnitude of CI₁ relative to at least one of the magnitudes of CI₂, CI₃, CI₄, CI₅, or CI₆ may be determined. For example, at the block 305, the method 300 may include evaluating one or more of the expressions (|CI₁|/|CI₂|), (|CI₁|/|CI₃|), (|CI₁|/|CI₄|), (|CI₁|/|CI₅|), (|CI₁|/|CI₆|, or (|CI₁)/(|CI₁|+|CI₂|+|CI₃|+|CI₄|+|CI₅|+|CI₆|))).

At a block 308, the method 300 may include adjusting the respective individual cybersecurity risk score of the subject entity based on the magnitude of the collective impact of the occurrence of the one or more adverse cybersecurity incidents at the subject entity relative to the respective magnitude of the collective impact of the occurrence of the one or more adverse cybersecurity incidents at one or more of the other entities. In an example implementation, the cybersecurity risk score adjustor 138 may perform the block 308. Referring again to FIG. 2 for illustration, at the block 308, the cybersecurity risk score CRS₁ of cyber-entity E₁ may be adjusted based on the magnitude of CI₁ (e.g., due to the occurrence of the one or more adverse cybersecurity incidents at E₁) relative to the magnitude of each of one or more of CI₂, CI₃, CI₄, CI₅, or CI₆ (e.g., due to the respective occurrence of the one or more cybersecurity incidents at each of one or more of E₂, E₃, E₄, E₅, and E₆). In some situations, CRS₁ of cyber-entity E₁ may be adjusted based on the relative magnitudes of CI₁ and one or more of CI₂, CI₃, CI₄, CI₅, and CI₆ due to the respective occurrence of the one or more adverse cybersecurity incidents at E₁ and at each of E₂, E₃, E₄, E₅, and E₆. In an example, the adjustment to CRS₁ may include applying a factor (1+p) to CRS₁ to thereby increase CRS₁ (e.g., (1+p)*CRS₁). In this example, p may be a term that is equal or proportional to the magnitudes of the collective impacts of all or an entirety of the entities included in the set 200 (e.g., (|CI₁)/(|CI₁|/(|CI₁|+|CI₂|+|CI₃|+|CI₄|+|CI₅|+|CI₆|))), in an embodiment. In another embodiment of this example, p may be based solely on the (sub)set of entities with which E₁ has a dependent relationship. For instance, p may be proportional to (|CI₁|/(|CI₁|+|CI₄|+|CI₅|)), where E₁, E₄, and E₅ are the set of entities, within the plurality of entities, that depend on E₁.

In another example, the adjustment to CRS₁ may include applying a factor (1−p) to CRS₁ to thereby decrease CRS₁ (e.g., (1−p)*CRS₁). In this example, p may be a penalty term that is equal or proportional to the magnitudes of the collective impacts of the entities, within the plurality of entities, on which E₁ depends. For instance, if E₁, E₄, and E₅ are the set of entities, within the plurality of entities, on which E₁ depends, p may be proportional to (|CI₁|/(|CI₁|+|CI₂|+|CI₃|+|CI₅|)).

As such, the adjustment to CRS₁ may be indicative of the level or magnitude of cybersecurity risk exposure that entity E₁ introduces to or generates for the plurality of entities E₁-E₆ as a whole, relative to the respective levels or magnitudes of risk exposure that one or more of the other entities E₂-E₆ introduce to or generate for the plurality of entities E₁-E₆ as a whole. Said another way, the CRS₁ of cyber-entity E₁ may be adjusted to indicate the risk exposure introduced by E₁ to a specific set 200 or group of cyber-entities that have a specific interdependency web and in which E₁ is included. For example, one or more of the cybersecurity risk scores CRS₁-CRS₆ may be weighted in accordance with the relative magnitudes determined at the block 305. In another example, the cybersecurity risk scores CRS₁-CRS₆ may be ranked or otherwise ordered in accordance with their respective magnitudes of introduced risk exposure. One or more of the adjusted cybersecurity risk scores may be stored in the cybersecurity risk score data store 102.

At a block 310, the method 300 may include mitigating a cybersecurity risk associated with the plurality of entities (e.g., the overall cybersecurity risk exposure or the cybersecurity risk of the plurality of entities as a whole) based on the adjusted, respective individual cybersecurity risk score of the subject entity. In an example implementation, the cybersecurity risk mitigator 140 may perform the block 310. As previously discussed, the adjusted cybersecurity risk score of the subject entity may be indicative of the cybersecurity risk exposure introduced by or generated for the plurality of entities by the subject entity. The mitigating 310 may include, for example, initiating and/or adding a new cybersecurity protection to the subject entity and/or to one or more entities included in the plurality of entities. Additionally or alternatively, the mitigating 310 may include, for example, initiating and/or causing a modification to an existing cybersecurity protection technique of the subject entity and/or of one or more entities included in the plurality of entities. For example, at least one of respective software or a respective computer network of one or more entities of the plurality of entities may be modified. For instance, a firewall between two entities may be strengthened, encryption and/or authentication between entities may be strengthened, thresholds may be adjusted, message delivery between two entities may be re-routed to use different paths within the network, and the like.

Additionally or alternatively, the mitigating 310 of the cybersecurity risk of the plurality of cyber-entities may include initiating and/or causing a modification to one or more cybersecurity policies associated with the plurality of entities. Generally speaking, the one or more cybersecurity policies may include, for example, best practices and/or procedures, standardized practices and/or procedures, a security policy (which may include one or more security products, services, and/or procedures), an Information Technology (IT) policy (which may include one or more IT products, services, and/or procedures), a vendor management policy, an insurance policy (e.g., a cyber-insurance policy and/or others), and/or a risk management policy, among others. The cybersecurity policy may include a portion which applies to each entity included in the plurality of entities (e.g., “any inter-entity communication must be encrypted”), and/or the cybersecurity policy may include a portion which applies to the plurality of entities as a whole (e.g., “an overall cybersecurity risk exposure of the plurality or set of entities as a whole must be below a threshold level, while individual cybersecurity risk exposures of members of the set of entities may be modifiable so long as the overall cybersecurity risk exposure of the plurality remains below the threshold level”). In some embodiments, the cybersecurity policy may apply to each entity within the plurality of entities commensurate with a respective level of risk exposure generated or introduced by each entity for the plurality of entities as a whole. For example, an entity which introduces a higher level of risk exposure to the plurality may be individually subject to more strict cybersecurity restrictions and protection techniques, whereas an entity which introduces a lesser or negligible level of risk exposure to the plurality may be individually subject to less strict cybersecurity restrictions and protection techniques. Accordingly, the mitigating 310 of the cybersecurity risk of the plurality of cyber-entities may include generating or modifying a value of a term, threshold, condition, etc. of a respective cybersecurity policy of one or more cyber-entities and/or of an overall cybersecurity policy of the plurality of cyber-entities, for example, and/or causing the initiation thereof.

In some situations, the mitigating 310 of the cybersecurity risk of the plurality of entities may be managed, at least in part, via cybersecurity insurance policies which are reflective of the interdependencies of the plurality of entities and the contributions, of each entity, to the overall risk exposure of the plurality of entities. In these situations, entities introducing relatively higher levels of risk exposures to the plurality of entities (e.g., as compared to other entities included in the plurality) may have a respective cybersecurity insurance policy which includes higher premiums, lower payout limits, reduced coverages, etc., whereas entities which introduce lower levels of cybersecurity risk exposure to the plurality of entities (e.g., as compared to other entities included in the plurality) may have a respective cybersecurity insurance policy which has lower premiums, higher payout limits, increased coverages, etc., at least as compared to other entities included in the plurality of interdependent entities. That is, the respective cybersecurity insurance policies of each entity within the plurality may be commensurate with a respective level of risk exposure generated or introduced by each entity for the plurality of interdependent entities as a whole, so that the terms of each individual entity's cybersecurity insurance policy reflect or is in accordance with the level of risk exposure generated or introduced by each entity to the plurality of entities. In these situations, the mitigating 310 of the cybersecurity risk of the plurality of entities may include generating or modifying a value of a term of a respective cybersecurity insurance policy of one or more cyber-entities included therein, for example, and/or causing the initiation thereof.

Still additionally or alternatively, the mitigating 310 of the cybersecurity risk of the plurality of cyber-entities may include initiating and/or causing a change to a cybersecurity dependency between two entities included in the plurality of entities. For example, a minimum set of requirements at one or both of two dependent entities may be increased before the two entities are allowed to interact; a first entity may change its dependency on a second entity to instead being dependent on a third entity which provides similar functionality as the second entity; an intervening entity may be added to the plurality of entities and disposed in between two entities (e.g., a firewall, encryption, authentication, etc.); one of the plurality of entities may be removed from the plurality and thus may no longer have any cyber-dependencies with any other entity of the plurality, etc. The entities for which the cybersecurity dependency is changed may or may not include the subject entity.

Of course one or more additional and/or alternative mitigation techniques may be employed at the block 310.

In an embodiment (not shown), the method 300 may include updating the relative magnitudes of the respective collective impacts corresponding to the plurality of entities based on one or more of the mitigation techniques which were initiated and/or performed at the block 310, and updating (and in some cases, further updating) one or more individual cybersecurity risk scores of one or more cyber-entities included in the plurality of cyber-entities based on the updates to the relative magnitudes of the respective collective impacts. This embodiment may additionally include evaluating, based on the (further) updated individual cybersecurity risk scores, whether any (further) mitigation of the respective cybersecurity risk of the plurality of cyber-entities as a whole is advisable or needed (e.g., based on one or more levels of thresholds of cybersecurity risk exposure levels, costs, etc.). If any (further) mitigation is advised or needed, the method 300 may include performing one or more (new and/or further) mitigation techniques, and/or adjusting or modifying one or more mitigation techniques that are currently being utilized within the plurality of entities or ecosystem, e.g., at one or more cyber-entities and/or within the ecosystem as a whole. It is noted that the one or more cyber-entities for which individual cybersecurity risk scores were updated based on the updated relative magnitudes of collective impacts may or may not be the same set of one or more cyber-entities for which new, further, adjusted, or modified mitigation techniques are employed.

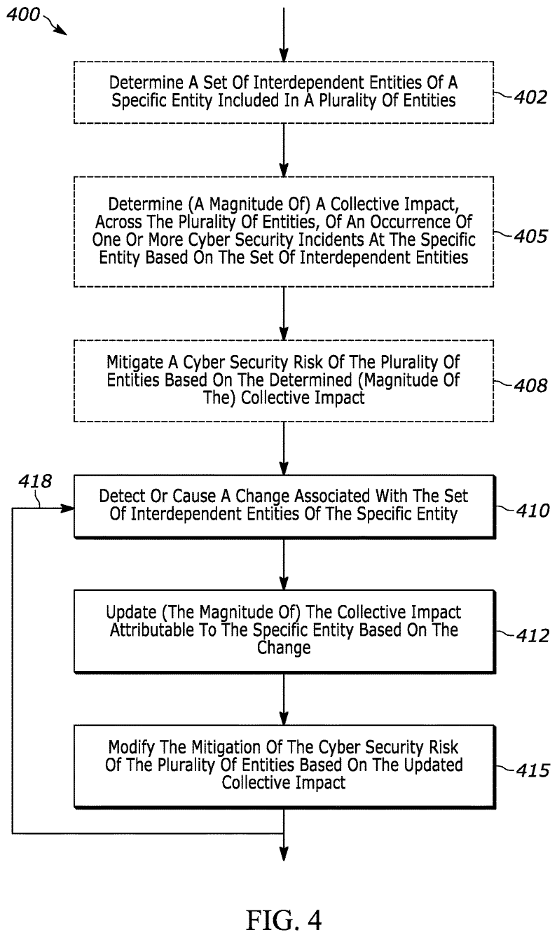

FIG. 3B depicts a flow diagram of an example method 350 for mitigating cybersecurity risks for a plurality of cyber-entities, such as a plurality of cyber-entities that have interdependencies among various cyber-entities of the plurality. The method 350 may operate as a stand-alone method or in conjunction with at least portions of the method 300 of FIG. 3A and/or the method 400 of FIG. 4 described herein. Additionally or alternatively, the method 350 may operate in conjunction with embodiments of at least a portion of the system 100 of FIG. 1 and of any one or more components and/or devices related thereto (such as, for example, the network(s) 122, the data stores 102, 104, the PEDs 152a-152c, etc.), and/or with other systems, processors, databases and/or devices. For example, the computing device(s) 112 may execute at least a portion of the method 350, at least a portion of the method 350 may be executed with respect to the example set 200 of cyber-entities depicted in FIG. 2, and/or at least a portion of the method 350 may be executed with respect to other sets of interdependent cyber-entities. In some arrangements, one or more of the components of the system 100 may execute an instance of the method 350, either individually or jointly. For example, the interdependencies generator 132, the collective impact generator 135, and cybersecurity risk mitigator 140 may perform at least a portion of the method 350. For ease of discussion, though, and not for limitation purposes, the method 350 is discussed with simultaneous reference to FIGS. 1, 2, and 3A. Further, the method 350 may include additional or alternate steps other than those described with respect to FIG. 3B, in embodiments. Further, as previously mentioned, the terms “cyber-entity” and “entity” are utilized interchangeably herein for ease of reading (and not limitation) purposes.

At a block 352, the method 350 may include, for each entity included in a plurality of entities, obtaining an indication of a respective set of entities, of the plurality of entities, with which the entity has cybersecurity dependencies. For example, at the block 352, the method 350 may include obtaining an indication of a respective set of interdependent entities of each entity included in the plurality of entities. Obtaining 352 the indication of the respective set of interdependent entities of each entity may be performed in a manner similar to that described for block 302 of FIG. 3A, in an embodiment. In an example implementation, the interdependence determiner 132 may perform the block 352.

At a block 355, the method 350 may include determining, for a particular or subject entity included in the plurality of entities, a collective impact, to or across the plurality of entities, of an occurrence of one or more cybersecurity incidents at the subject entity based on the set of interdependent entities of the subject entity. In an example implementation, the collective impact generator 125 may perform the block 355. As previously discussed, the collective impact corresponding to the subject entity may be based on the primary impact to the subject entity as well as secondary impacts to entities with which the subject entity has cybersecurity dependencies. In some cases, the collective impact corresponding to the subject entity may be further based on tertiary and further-removed impacts to other entities within the plurality.

Accordingly, the collective impact to or across the plurality of entities (e.g., CIₓ, as discussed above with respect to FIG. 2) may be indicative of a level of cybersecurity risk or a magnitude of cybersecurity risk exposure which the subject entity generates for the plurality of entities as a whole, in embodiments. Additionally, determining 355 the collective impact on the plurality of entities that is attributable to the subject entity may include observing, quantifying, or otherwise measuring the collective impact due to one or more actual occurrences of cybersecurity incidents at the subject entity, and/or may include estimating, predicting, or projecting the collective impact were the one or more cybersecurity incidents to occur at the subject entity.

In some embodiments, at the block 355, the method 350 includes determining the collective impact on the plurality of entities that is attributable to the subject entity further based on a magnitude of a cybersecurity risk exposure of the specific entity. As previously discussed, the cybersecurity risk exposure of the specific entity may be a stand-alone risk exposure or may be a risk exposure which reflects the interdependencies of the specific entity within the plurality of entities. The magnitude of the cybersecurity risk exposure of the specific entity may have been pre-determined by utilizing one or more actuarial techniques (e.g., tables, schedules, etc.) and/or by utilizing one or more automated techniques (e.g., machine learning, artificial intelligence, etc.). In some embodiments, the method 350 includes determining the magnitude of the cybersecurity risk exposure of the specific entity in-line with the execution of the method 350. In some embodiments, the method 350 includes determining the collective impact on the plurality of entities that is attributable to the subject entity further based on the magnitudes of respective cybersecurity risk exposures of more than one entity included in the plurality, which may include a subset of the entirety of entities included in the plurality, or may include the entirety of the entities included in the plurality.

At a block 358, the method 350 may include mitigating a cybersecurity risk of the plurality of entities (e.g., the overall cybersecurity risk exposure, or the cybersecurity risk of the plurality of entities as a whole) based on the collective impact determined at the block 355. As previously discussed, the collective impact to or across the plurality of entities may be indicative of a level of cybersecurity risk or a magnitude of cybersecurity risk exposure which the subject entity generates for the plurality of entities, e.g., as a whole, and thus mitigating 358 of the cybersecurity risk of the plurality of entities may include initiating or performing one or more mitigation techniques to decrease or lessen the collective impact, on or across the plurality of entities, which is attributable to the subject entity. Mitigation techniques may include techniques similar to those discussed above with respect to FIG. 3A, such as adding and/or modifying cybersecurity protection techniques at one or more entities and/or to the plurality or ecosystem of entities as a whole, modifying software and/or networks corresponding to one or more entities and/or to the plurality or ecosystem of entities as a whole, adding and/or modifying a cybersecurity policy or respective portion thereof applied to one or more entities and/or to the plurality or ecosystem of entities of a whole (e.g., adding and/or modifying a term, threshold, condition, etc.), initiating and/or causing a change to one or more cybersecurity dependencies within the plurality of entities, and/or other types of suitable or desired mitigation techniques. One or more mitigation techniques may be initiated or performed at the subject entity, and/or one or more mitigation techniques may be initiated and/or performed at other entities of the plurality of entities. In an example implementation, the cybersecurity risk mitigator 140 may perform the block 358.

In an embodiment (not shown), the method 350 may include updating the collective impact, to or across the plurality of entities, which is attributable to the subject entity, e.g., based on one or more of the mitigation techniques which were initiated and/or performed at the block 358. This embodiment may additionally include evaluating, based on the updated collective impact attributable to the subject entity, whether any (further) mitigation of cybersecurity risk is advisable or needed, e.g., based on the updated collective impact. If any (further) mitigation is advised or needed, the method 350 may include performing one or more (new and/or further) mitigation techniques, and/or adjusting or modifying one or more of the presently-utilized mitigation techniques within the ecosystem.

In an embodiment (not shown), the block 355 of the method 350 may include determining, for each entity included in the plurality of entities, a respective collective impact, to or across the plurality of entities, of an occurrence of one or more cybersecurity incidents at each entity. In this embodiment, the block 358 of the method 350 may include mitigating the cybersecurity risk of the plurality of entities based on the plurality of collective impacts determined at the block 355.

Further, while the methods 300 and 350 are described with respect to levels of cybersecurity risk and/or cybersecurity risk scores of entities, it is understood that these are only examples of various aspects of an ecosystem or plurality of interdependent entities which can be utilized in providing cybersecurity risk mitigation for the ecosystem. For example, instead of using the levels of cybersecurity risk and the cybersecurity risk scores of entities, the method 300 and/or the method 350 may utilize respective levels of cybersecurity and/or cybersecurity risk scores of the dependency connections between entities (e.g., of each of the dependency arrows shown in FIG. 2). Additionally or alternatively, the method 300 and/or the method 350 may utilize respective conductivity rates of the dependency connections between entities, and/or other aspects.

Turning now to FIG. 4, FIG. 4 depicts a flow diagram of an example method 400 for mitigating cybersecurity risks for a specific cyber-entity that is included in a plurality of cyber-entities including interdependent cyber-entities, e.g., in an ecosystem of cyber-entities that includes cyber-dependencies. The method 400 may operate as a stand-alone method or in conjunction with at least portions of the method 300 of FIG. 3A and/or the method 350 of FIG. 3B described herein. Additionally or alternatively, the method 400 may operate in conjunction with embodiments of at least a portion of the system 100 of FIG. 1 and of any one or more components and/or devices related thereto (such as, for example, the network(s) 122, the data stores 102, 104, the PEDs 152a-152c, etc.), and/or with other systems, processors, databases and/or devices. For example, the computing device(s) 112 may execute at least a portion of the method 400, at least a portion of the method 400 may be executed with respect to the example set 200 of cyber-entities depicted in FIG. 2, and/or at least a portion of the method 400 may be executed with respect to other sets of interdependent cyber-entities. In some arrangements, one or more of the components of the system 100 may execute an instance of the method 400, either individually or jointly. For example, the collective impact generator 135, the cybersecurity risk mitigator 140, and the change determiner 145 may perform at least a portion of the method 400. For ease of discussion, though, and not for limitation purposes, the method 400 is discussed with simultaneous reference to FIGS. 1, 2, 3A, and 3B. Further, the method 400 may include additional or alternate steps other than those described with respect to FIG. 4, in embodiments. Further, and as previously mentioned, the terms “cyber-entity” and “entity” are utilized interchangeably herein for ease of reading (and not limitation) purposes.

At an optional block 402, the method 400 may include determining a set of other cyber-entities that are included in the plurality of cyber-entities and with which the specific cyber-entity has cybersecurity dependencies, e.g., one-way cybersecurity dependencies and mutual cybersecurity dependencies. The set of other cyber-entities with which the specific entity has cybersecurity dependencies may be a set of interdependent entities of the specific entity, and the determining 402 of the set of interdependent entities of the specific entity may be performed in a manner similar to that discussed elsewhere within this document. In an example implementation, the interdependencies determiner 132 may execute the block 402.

At an optional block 405, the method 400 may include, based on the set of interdependent entities of the specific entity, determining, for the specific entity, a magnitude of a collective impact, across the plurality of entities, of an occurrence of one or more cybersecurity incidents at the specific entity. Determining 405 the magnitude of the collective impact may be performed in a manner similar to that described for block 305 of FIG. 3A and/or block 355 of FIG. 3B, in an embodiment. For example, the determining 405 may or may not be based on the levels of respective cybersecurity risk of the specific entity and/or of other entities included in the plurality. In an example implementation, the collective impact generator 135 may perform the block 405.

At an optional block 408, the method 400 may include mitigating a cybersecurity risk of the plurality of cyber-entities (e.g., the overall cybersecurity risk exposure, or the cybersecurity risk of the plurality of entities as a whole) based on the collective impact determined at the block 405. As previously discussed, the collective impact to or across the plurality of cyber-entities may be indicative of a level of cybersecurity risk or a magnitude of cybersecurity risk exposure which the subject cyber-entity generates for the plurality of cyber-entities, e.g., as a whole, and thus mitigating 408 of the cybersecurity risk of the plurality of cyber-entities may include initiating or performing one or more mitigation techniques to decrease or lessen the collective impact, on or across the plurality of cyber-entities, which is attributable to the subject entity. Mitigation techniques may include techniques similar to those discussed above with respect to FIG. 3A and FIG. 3B, such as adding and/or modifying cybersecurity protection techniques at one or more cyber-entities and/or to the plurality or ecosystem of cyber-entities as a whole, modifying software and/or networks corresponding to one or more cyber-entities and/or to the plurality or ecosystem of cyber-entities as a whole, adding and/or modifying a cybersecurity policy or respective portion thereof applied to one or more cyber-entities and/or to the plurality or ecosystem of cyber-entities of a whole (e.g., adding and/or modifying a term, threshold, condition, etc.), initiating and/or causing a change to one or more cybersecurity dependencies within the plurality of cyber-entities, and/or other types of suitable or desired mitigation techniques. In an example implementation, the cybersecurity risk mitigator 140 may perform the block 408.

It is noted that, generally speaking, the blocks 402-408 of the method 400 may be similar to the blocks 352-358 of the method 350. In some embodiments of the method 400, though, any one or more of the blocks 402-408 may be optional and omitted from the method 400, as denoted in FIG. 4 by the dashed lines.

At a block 410, the method 400 may include detecting or causing a change that is associated with one or more cybersecurity dependencies of the specific entity. In an example implementation, the change determiner 145 may perform the block 310. In an example, detecting or causing 410 the change associated with one or more cybersecurity dependencies of the specific entity may include detecting an occurrence of at least one cybersecurity incident (which may include an adverse cybersecurity incident and/or a beneficial cybersecurity incident) at the specific entity and/or at another entity with which the specific entity has a cybersecurity-dependent relationship. In another example, detecting or causing 410 the change associated with one or more cybersecurity dependencies of the specific entity may include detecting or causing an addition of another cyber-entity to the plurality of cyber-entities. The added cyber-entity may be a new cyber-entity that augments the plurality of cyber-entities to include yet another cyber-entity, or the added-cyber entity may be a substitution for an existing cyber-entity of the plurality of cyber-entities. The added cyber-entity may or may not be included in the set of interdependent entities of the specific cyber-entity. For example, the added cyber-entity may be dependent on the specific cyber-entity, the specific cyber-entity may be dependent on the added cyber-entity, or the added cyber-entity may not have any cybersecurity-dependent relationship with the specific cyber-entity and instead may have a cybersecurity dependency with another cyber-entity included in the plurality. When a new cyber-entity is added to augment the plurality of cyber-entities, the method 400 may include obtaining at least one of a respective individual cybersecurity risk score of the new cyber-entity, or an indication of a set of interdependencies of the new cyber-entity within the plurality of entities (not shown).

In yet another example, detecting or causing 410 the change associated with one or more cybersecurity dependencies of the specific entity may include a removal of an existing cyber-entity from the plurality of cyber-entities, e.g., without substituting another cyber-entity in its place. The removed cyber-entity may or may not have been included in the set of interdependent entities of the specific cyber-entity.

As such, changes associated with the one or more cybersecurity dependencies of the specific entity may include a change to the membership of the set of interdependent entities of the specific entity; to the strengths of one or more connections within the members of the set of interdependent entities; to a type, number, or rate of occurrence of various cybersecurity incidents at the specific entity and/or at other entities within the ecosystem, and the like. In some embodiments, the change associated with the one or more cybersecurity dependencies of the specific entity may include (or result from) an implementation of a new or modified cybersecurity and/or mitigation technique somewhere within the ecosystem. Of course, other changes which are associated with or have in impact on the cyber security dependencies of the specific entity are possible.

At a block 412, the method 400 may include updating the collective impact, across the plurality of entities, of the occurrence of the one or more cybersecurity incidents at the specific entity based on the change. For example, at the block 412, the method 400 may determine, based on the change, an updated level of cybersecurity risk and/or an updated magnitude of risk exposure, and may subsequently determine the updated collective impact, across the (potentially revised) plurality of entities of the occurrence of one or more cybersecurity incidents at the specific entity and optionally the magnitude of the updated collective impact (e.g., based on the updated level of cybersecurity risk, the updated collective impact attributable to the specific entity, and/or one or more changed sets of interdependencies within the ecosystem). In some implementations, at the block 412 the method 400 may update the relativities of the magnitudes of the collective impact attributable to the subject entity and of the collective impacts attributable to other entities of the plurality, e.g., based on the updated collective impact corresponding to the subject entity. In an example implementation, the collective impact generator 135 may perform the block 412.

At a block 415, the method 400 may include modifying the mitigation of the cybersecurity risk of the plurality of entities based on the updated collective impact. The modification of the mitigation may be generally performed in a manner similar to that discussed with respect to the block 408, albeit based on a different (updated) collective impact and possibly a differently configured ecosystem of cyber-entities. In an example implementation, the cybersecurity risk mitigator 140 may perform the block 415.

In some embodiments, and advantageously, the adaptation to changing cybersecurity dependencies within the (or a potentially changing) ecosystem may be repeated over time, e.g., as additional changes affecting the ecosystem's cybersecurity dependencies are detected. In these situations, the method 400 may return from the block 415 to the block 410, as denoted by the reference 418. In some embodiments, an instance of the method 400 may be executed (e.g., sequentially and/or in parallel) for different cyber-entities included in the plurality of cyber-entities. Accordingly, the method 400 may provide on-going, adaptable, and responsively-customized cybersecurity protection over time for an ecosystem of cyber-entities that have cybersecurity interdependencies as the conditions affecting the cybersecurity interdependencies are changed, modified, and/or subject to occurrences of cybersecurity incidents.

In some embodiments, at least portions of the method 400 may be utilized in conjunction with other methods described within this disclosure. For example, at least some of the blocks 410-418 may be performed in conjunction with the method 300, or at least some of the blocks 410-418 may be performed in conjunction with the method 350. As such, with the addition of the blocks 410-418, each of the methods 300 and 350 can be responsive to changes that affect cybersecurity dependencies within the respective ecosystem in which the method is executing, and as such can provide updated cybersecurity protection that is customized to the cyber-entities of the ecosystem when and as changes to the ecosystem occur.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

Further, although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims and all equivalents thereof.

What is claimed:

1. A method of mitigating cybersecurity risks for a plurality of entities, the method comprising:
for each entity included in the plurality of entities, obtaining a respective individual cybersecurity risk score of the each entity and an indication of a respective set of entities, of the plurality of entities, with which the each entity has cybersecurity dependencies, the respective set of entities with which the each entity has cybersecurity dependencies being a respective set of interdependent entities of the each entity;
based on the sets of interdependent entities of the plurality of entities and the respective individual cybersecurity risk score of a particular entity of the plurality of entities, determining, for the particular entity, a magnitude of a respective collective impact, across the plurality of entities, of an occurrence of one or more cybersecurity incidents at the particular entity relative to magnitudes of respective collective impacts, across the plurality of entities, of occurrences of the one or more cybersecurity incidents at other entities included in the plurality of entities;
adjusting the respective individual cybersecurity risk score of the particular entity based on the relative magnitude of the respective collective impact corresponding to the particular entity; and
mitigating a cybersecurity risk of the plurality of entities based on the adjusted, respective individual cybersecurity risk score of the particular entity.

2. The method of claim 1, further comprising:
determining, for the each entity and based on the individual cybersecurity risk scores of the plurality of entities and the sets of interdependent entities of the plurality of entities, a magnitude of a respective collective impact, across the plurality of entities, of the occurrence of the one or more cybersecurity incidents at the each entity relative to magnitudes of respective collective impacts, across the plurality of entities, of occurrences of the one or more cybersecurity incidents at respective other entities included in the plurality of entities;
adjusting the respective individual cybersecurity risk score of the each entity based on the relative magnitude of the respective collective impact corresponding to the each entity; and
mitigating a respective cybersecurity risk of the each entity based on the plurality of adjusted individual cybersecurity risk scores of the plurality of entities, thereby mitigating a cybersecurity risk of the plurality of entities as a whole.

3. The method of claim 1, further comprising determining, by utilizing one or more machine-learning or artificial intelligence techniques, the respective, individual cybersecurity risk score of the each entity of at least some of the plurality of entities based on one or more current cybersecurity policies or products utilized by the each entity, and optionally based on a respective set of interdependent entities of the each entity.

4. The method of claim 1, further comprising:
obtaining an indication of a change to one or more respective, individual cybersecurity risk scores of at least some of the plurality of entities;
updating the magnitude of the respective collective impact of the occurrence of the one or more cybersecurity incidents at the particular entity relative to the magnitudes of the respective collective impacts of the occurrences o the one or more cybersecurity incidents at the other entities based on the change; and
modifying the mitigation of the cybersecurity risk of the plurality of entities based on the updated collective impact.

5. A method of mitigating cybersecurity risks for a plurality of entities, the method comprising:
obtaining, for each entity included in the plurality of entities, an indication of a respective set of entities, of the plurality of entities, with which the each entity has cybersecurity dependencies, the respective set of entities with which the each entity has cybersecurity dependencies being a respective set of interdependent entities of the each entity;
based on the sets of interdependent entities of the plurality of entities, determining a collective impact, across the plurality of entities, of an occurrence of one or more cybersecurity incidents at a particular entity included in the plurality of entities, the collective impact based on a primary impact, to the particular entity, of the occurrence of the one or more cybersecurity incidents at the particular entity and respective secondary impacts, to other entities included in the plurality of entities, of the occurrence of the one or more cybersecurity incidents at the particular entity; and
mitigating a cybersecurity risk of the plurality of entities based on the collective impact, across the plurality of entities, of the occurrence of the one or more cybersecurity incidents at the particular entity.

6. The method of claim 5, wherein the collective impact across the plurality of entities is indicative of a magnitude of a cybersecurity risk exposure of the plurality of entities as a whole.

7. The method of claim 5, wherein determining the collective impact of the occurrence of the one or more cybersecurity incidents at the particular entity is further based on a magnitude of cybersecurity risk exposure of the particular entity.

8. The method of claim 7, wherein the magnitude of cybersecurity risk exposure of the particular entity is determined based on one or more actuarial techniques, tables, or schedules.

9. The method of claim 7, wherein the magnitude of cybersecurity risk exposure of the particular entity is determined based on one or more machine learning or artificial intelligence techniques.

10. The method of claim 5, further comprising:
obtaining an indication of a new entity being added to the plurality of entities and an indication of a set of interdependent entities of the new entity;
updating the collective impact of the occurrence of the one or more cybersecurity incidents at the particular entity based on the set of interdependent entities of the new entity; and
modifying the mitigation of the cybersecurity risk of the plurality of entities based on the updated collective impact.

11. The method of claim 5, further comprising:
obtaining an indication of a specific entity being removed from the plurality of entities;
updating the collective impact of the occurrence of the one or more cybersecurity incidents at the particular entity based on the removal of the specific entity; and
modifying the mitigation of the cybersecurity risk of the plurality of entities based on the updated collective impact.

12. The method of claim 5, further comprising:
obtaining an indication of an occurrence of a particular cybersecurity incident at the particular entity or at another entity included in the plurality of entities;
updating the collective impact of the occurrence of the one or more cybersecurity incidents at the particular entity based on the occurrence of the particular cybersecurity incident at the particular entity or at the another entity; and
modifying the mitigation of the cybersecurity risk of the plurality of entities based on the updated collective impact.

13. The method of claim 5, wherein mitigating the cybersecurity risk of the particular entity includes one or more of:
causing a modification to at least one of respective software or a respective computer network of one or more entities of the plurality of entities; or
causing a change to a cybersecurity dependency between two entities included in the plurality of entities.

14. The method of claim 13, further comprising:
updating the collective impact of the occurrence of the one or more cybersecurity incidents at the particular entity based on at least one of: the modification to the at least one of the respective software or the respective computer network of the one or more entities, or the change to the cybersecurity dependency between the two entities; and
modifying the mitigation of the cybersecurity risk of the plurality of entities based on the updated collective impact.

15. The method of claim 5, wherein mitigating the cybersecurity risk of the plurality of entities includes at least one of: generating or modifying a value of a term of a cybersecurity policy of the particular entity.

16. The method of claim 5, further comprising:
for the each entity of the plurality of entities and based on the sets of interdependent entities of the plurality of entities, determining a respective collective impact, across the plurality of entities, of an occurrence of the one or more cybersecurity incidents at the each entity, the respective collective impact based on a respective primary impact, to the each entity, of the occurrence of the one or more cybersecurity incidents at the each entity and respective secondary impacts, to respective other entities included in the plurality of entities, of the occurrence of the one or more cybersecurity incidents at the each entity; and
mitigating a cybersecurity risk of the plurality of entities as a whole based on the collective impacts of the occurrences of the one or more cybersecurity incidents at the plurality of entities.

17. The method of claim 16, wherein mitigating the cybersecurity risk of the plurality of entities as the whole includes one or more of:
causing a modification to at least one of respective software or a respective computer network of one or more entities of the plurality of entities; or
causing a change to a cybersecurity dependency between two entities included in the plurality of entities.

18. The method of claim 16, wherein mitigating the cybersecurity risk of the plurality of entities as the whole includes generating or modifying a value of a respective term of at least one of: a cybersecurity policy of the plurality of entities as the whole or a respective cybersecurity policy of at least one entity included in the plurality of entities.

19. The method of claim 5, wherein determining the collective impact of the occurrence of the one or more cybersecurity incidents at the particular entity is further based on a plurality of individual cybersecurity risk scores of the plurality of entities.

20. A system configured to perform the method of claim 5.
